(19) United States
(12) Patent Application Publication
(10) Pub. No.: US 2023/0036230 A1
(43) Pub. Date: Feb. 2, 2023

(54) SYSTEM, BASE STATION AND WIRELESS DEVICE FOR LOCATION TRACKING

(71) Applicant: RUTLEDGE OMNI SERVICES PTE. LTD., Singapore (SG)

(72) Inventors: Jake BERLOCHER, Singapore (SG); Pak Khong LAI, Singapore (SG)

(73) Assignee: RUTLEDGE OMNI SERVICES PTE. LTD., Singapore (SG)

(21) Appl. No.: 17/785,109

(22) PCT Filed: Dec. 19, 2019
(86) PCT No.: PCT/SG2019/050625

§ 371 Date: Jun. 14, 2022

(51) Int. Cl. H04W 64/00; H04W 52/02

(52) U.S. Cl. CPC H04W 64/00; H04W 52/0229; H04W 52/0216

(57) ABSTRACT

A wireless device is disclosed. The wireless device has an ID and includes a processor, a timer and a signal strength detector. The timer is configured to timeout after a predetermined period to bring the processor from a sleep mode to an active mode so that the processor is able to receive a beacon message from at least one base station. The beacon message includes an ID of the respective base station. The processor is further able to transmit a first location reporting message that includes the wireless device ID and the base station ID. The signal strength detector is able to receive a wakeup message from a base station for bringing the processor from the sleep mode to the active mode to transmit a second location reporting message that includes the wireless device ID and an ID of the base station transmitting the wakeup message. A system including the wireless device and the base station is also disclosed.

### FIELD OF INVENTION

The present disclosure relates to a location tracking system. More particularly, the present disclosure relates to a wireless device and a location tracking system for tracking the location of multiple wireless devices using multiple mesh routers.

### BACKGROUND

The following discussion of the background to the invention is intended to facilitate an understanding of the present invention only. It should be appreciated that the discussion is not an acknowledgement or admission that any of the material referred to was published, known or part of the common general knowledge of the person skilled in the art in any jurisdiction as at the priority date of the invention.

In a facility/work environment/worksite (e.g., an industrial facility such as a factory or a refinery), it is important to have awareness of the location of working personnel during an emergency situation/event, such as a fire outbreak. This is particularly relevant in the context of a hazardous worksite, environment or facility.

Conventionally, drills (e.g., fire drills/muster drills) are conducted to prepare working personnel for an emergency situation/event. For example, fire drills can be periodically conducted to prepare workers for emergency evacuation in the event of a fire outbreak.

Such safety drills are, however, inefficient and/or unreliable. In one example, conventional safety drills are inefficient as time would be required to ensure all workers are accounted for after they have assembled in a designated safety gathering location/point (e.g., by manner of a manual headcount). In another example, conventional drills are considered to be unreliable as miscounts (e.g., during a headcount after the workers have been assembled) can potentially occur and this could lead to potential misinformation, during an emergency situation, that everyone has been accounted for when it is not actually the case.

There is therefore a need for a solution which addresses, at least in part, one or more of the forgoing problems.

### SUMMARY OF THE INVENTION

In accordance with an aspect of the invention, there is provided a wireless device having a respective identity (ID) for data communication with one or more base stations. The wireless device includes a processor that is operable in either a sleep mode or an active mode. The wireless device also includes a transceiver that is coupled to the processor. The wireless device further includes a timer that can be configured to timeout after a predetermined period to bring the processor from the sleep mode to the active mode to perform the first function. The first function includes the processor receiving, via the transceiver, a beacon message from one or more base stations. Each beacon message includes an ID of the respective base station transmitting it. The first function further includes the processor transmitting, via the transceiver, a first location reporting message to a base station. The first location reporting message includes the wireless device ID and the base station ID. The wireless device further includes a signal strength detector that is coupled to the processor. The signal strength detector can receive a wakeup message from a base station for bringing the processor from the sleep mode to the active mode so as to perform a second function. The wakeup message includes an ID of the mesh router transmitting it. The second function includes the processor transmitting, via the transceiver, a second location reporting message that includes the wireless device ID and the base station ID of a base station.

In some embodiments, the wakeup message is of a longer duration than the beacon message. Preferably, the wakeup message is of a higher signal strength than the beacon message.

In some embodiments, in one embodiment, receiving a beacon message includes receiving a beacon message during a beacon listening period when the processor is in the active mode. And in this embodiment, sending the first location reporting message includes sending the first location reporting message at the end of the beacon listening period. Further in this embodiment, the first function also includes returning the processor to the sleep mode after sending the first location reporting message.

In some embodiments, the second function further includes returning the processor to the sleep mode after sending the second location reporting message.

In some embodiments, the first reporting message further includes a signal strength of each beacon message.

In some embodiments, the first function or the second function further includes receiving a timer value change message from a base station for changing the predetermined period of the timer.

In some embodiments, the first function or the second function further includes receiving a turn timer on/off message from a base station for turning the timer on or off.

According to another aspect of the invention, there is provided a system that includes one or more of the wireless device mentioned

In some embodiments, the system further includes one or more base stations. Each base station being operable to transmit a respective wakeup message and/or a beacon message, and to receive the first location reporting message and the second location reporting message from the wireless device.

In some embodiments, the system further includes a server coupled to the one or more base stations. The server being operable to receive the first location reporting message and the second location reporting message from the one or more base stations for determining a location of the one or more wireless devices.

According to yet another aspect of the invention, there is provided a base station for communicating with multiple wireless devices, wherein each wireless device has a timer. The base station includes a processor and a transceiver coupled to the processor. The processor is operable to broadcast to the wireless devices, via the transceiver, a wakeup message and/or a beacon message, and a turn timer on/off message.

In some embodiments, the turn timer on/off message includes an ID of each wireless device whose timer is to be turned on or off.

Other aspects and advantages of the invention will become apparent from the following detailed description, taken in conjunction with the accompanying drawings, illustrating by way of example the principles of the invention.

### BRIEF DESCRIPTION OF THE DRAWINGS

The invention will be better understood with reference to the drawings, in which:

FIG. 1 is a drawing illustrating a system according to an embodiment of the invention;

FIG. 2 is a drawing illustrating a mesh radio network that can be used in the system in FIG. 1,

FIG. 3 is a drawing illustrating a communication network of a different topology than the one in FIG. 2 that can also be used in the system in FIG. 1;

FIG. 4 is a block diagram illustrating typical elements of a server used in the system of FIG. 1.

FIG. 5 is block diagram showing elements of a wireless device used in the system of FIG. 1;

FIG. 6 is a flowchart of a timer interrupt service routine performed by a processor of the wireless device in FIG. 5;

FIG. 7 is a flowchart of an external interrupt service routine performed by a processor of the wireless device in FIG. 5;

FIG. 8 is a flowchart of a location tracking method performed by the system in FIG. 1.

### DETAILED DESCRIPTION

Throughout this document, unless otherwise indicated to the contrary, the terms “comprising”, “consisting of”, “having” and the like, are to be construed as non-exhaustive, or in other words, as meaning “including, but not limited to”.

Furthermore, throughout the specification, unless the context requires otherwise, the word “include” or variations such as “includes” or “including” will be understood to imply the inclusion of a stated integer or group of integers but not the exclusion of any other integer or group of integers.

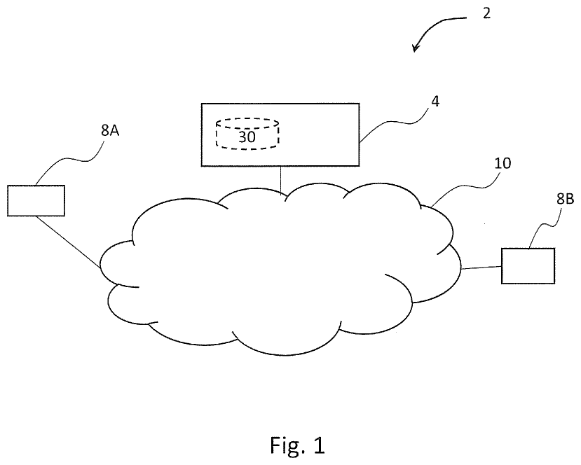

As shown in the drawings for purposes of illustration, the invention may be embodied in a novel system for tracking the location of wireless devices. Referring to FIGS. 1 to 8, a system embodying the invention generally includes multiple base stations coupled to a server for data communication therebetween. The system further includes multiple wireless devices in data communication with the multiple base stations. Each base station and each wireless device has a respective identity number (ID). The wireless device includes a processor, a transceiver, a signal strength detector and a timer. The processor can be operated in a sleep mode or an active mode. Both the transceiver and the signal strength detector are coupled to the processor. The timer is configured to timeout after a predetermined period to bring the processor from the sleep mode to the active mode to perform a first function. The signal strength detector is able to receive a wakeup message from a base station for bringing the processor from the sleep mode to the active mode to perform a second function. The wakeup message includes an ID of the base station transmitting it. The first function includes the processor receiving, via the transceiver, a beacon message from one or more base stations. Each beacon message includes an ID of the respective base station. The first function further includes the processor transmitting, via the transceiver, a first location reporting message that includes the wireless device ID and the base station ID. The second function includes the processor transmitting, via the transceiver, a second location reporting message that includes the wireless device ID and the base station ID.

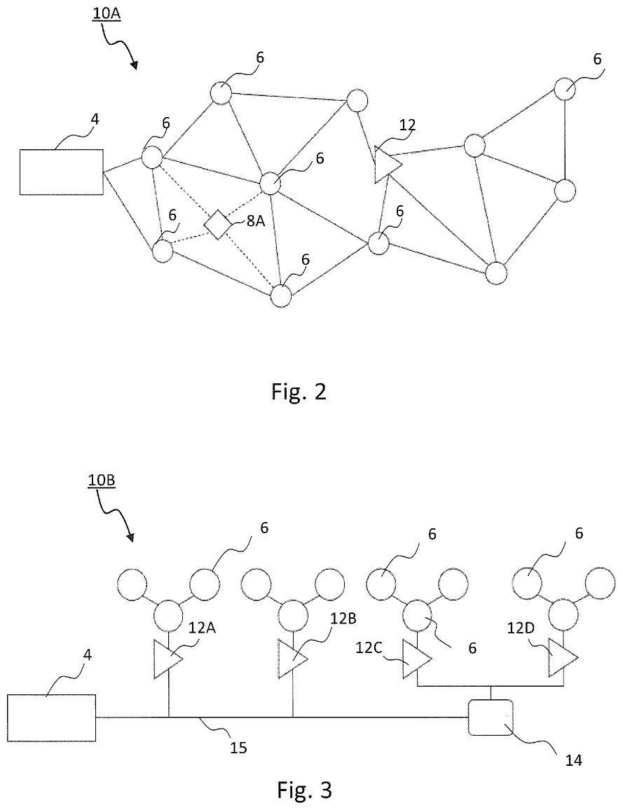

Specifically, FIGS. 1-3 show the above system. FIG. 1 is a diagram illustrating a system 2 according to an embodiment of the invention. This system 2 can, for example, be used for tracking the location of workers in a worksite. The system 2 includes a server 4, multiple base stations 6 (FIGS. 2 and 3) and multiple wireless devices 8A, 8B. The multiple base stations 6 are coupled to the server 4 via a network 10 to be in data communication with one another. The network 10 may be a wired network or a wireless network. The wireless devices 8A, 8B are in wireless data communication with the base stations 6. Details of the communication between the wireless devices 8A, 8B and the base stations 6 will be described in detail later. As used herein, unless expressly stated otherwise, “coupled” means that one node directly or indirectly communicates with another node and does not necessarily mean a direct communication link therebetween. Additional intervening nodes may be present.

In one embodiment, the communication network 10 may include a mesh-based communication network such as a mesh radio network 10A as shown in FIG. 2. The mesh radio network 10A includes a server 4, a gateway 12 and multiple mesh routers 6 that function as base stations 6 wirelessly coupled in a mesh topology. In this mesh radio network 10A, the server 4 also functions as a mesh router 6. Therefore, in this mesh radio network 10A, each of the server 4 and the gateway 12 includes a M.2 form factor radio transceiver implementing the IEEE 802.15.4 wireless networking protocol operating at 2.4 GHz. The IEEE 802.15.4 is a technical standard which defines the operation of low-rate wireless personal area networks (LR-WPANs). The standard specifies the physical and media access control for LR-WPANs. These layers are used in wireless communication protocols, including, but not limited to, Zigbee, WirelessHART, MiWi, Thread and SNAP. Any one of these may be used for wireless communications in this invention. Those skilled in the art would recognize that other communication protocols, not specifically mentioned here, may also be used in this invention. Each of the mesh routers 6 includes a radio transceiver (not shown) for communication with the other mesh routers 6, the gateway 12 and the server 4. In such a mesh radio network 10A, messages may flow from one mesh router 6 to another mesh router 6 via one of several message delivery routes. When one route between any two mesh routers 6 in the network 10A is unavailable, messages between the two mesh routers 6 may be routed over one or more alternative routes. The availability and reliability of such a network 10A is therefore high because of the built-in redundancy. FIG. 2 also shows a wireless device 8A in the vicinity of four mesh routers 6. It should be noted that the communication network 10 is not to be limited to such a mesh radio network 10A.

Other wired and wireless networks of any topology may also be used in the system 2. One other possible mesh-based communication network 10 is a network 10B having a server 4, multiple gateways 12A, 12B, 12C, 12D, a network router 14 and mesh routers 6 as shown in FIG. 3. The server 4 is coupled to the gateways 12A, 12B and the network router 14 via an Ethernet 15. The server 4 and the network router 14 in this network 10B do not include any radio transceiver. The gateways 12A, 12B, 12C, 12D are wirelessly coupled to the mesh routers 6. In such mesh-based communication networks, latency and throughput is highly dependent on the number of hops messages from a source node are required to travel to reach a destination node. To reduce the hop counts, more gateways 12A, 12B, 12C, 12D may be added to a network. Additionally, by having more than one gateway 12A, 12B, 12C, 12D in a network, more than one route of message delivery is available between two nodes. In the case when one route is unavailable, another route can be established for the delivery of a message. For example, in the network 10B, if the gateway 12A fails, the mesh routers 6 coupled thereto will establish new connections with another gateway 12B either directly or via other mesh routers 6 coupled to the gateway 12B. Single points of failure in the network 10B is thus eliminated. In any of the networks 10A, 10B, the server 4 may be clustered to also avoid single points of failure. A gateway 12 functions as a border router, routing messages between the server 4 and the mesh routers 6.

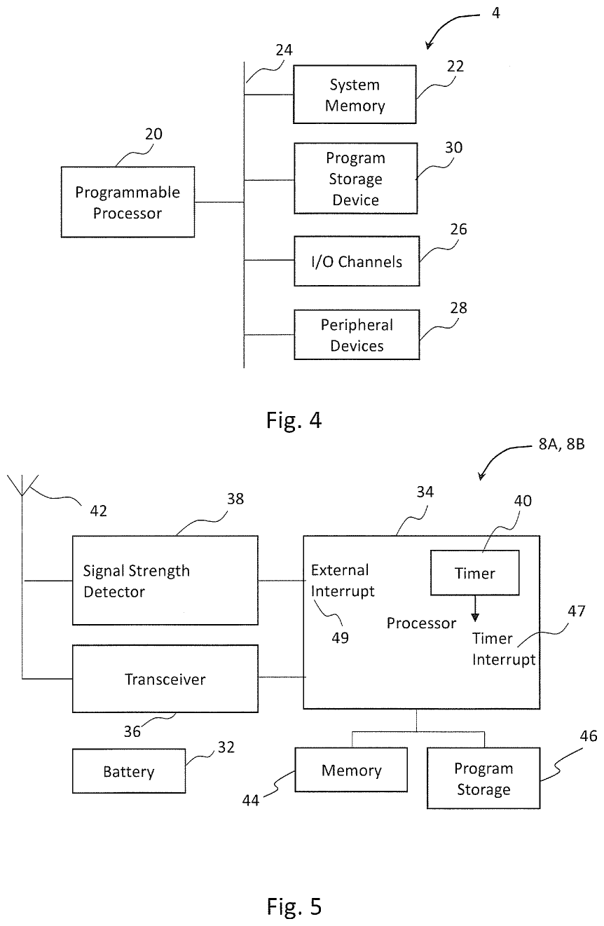

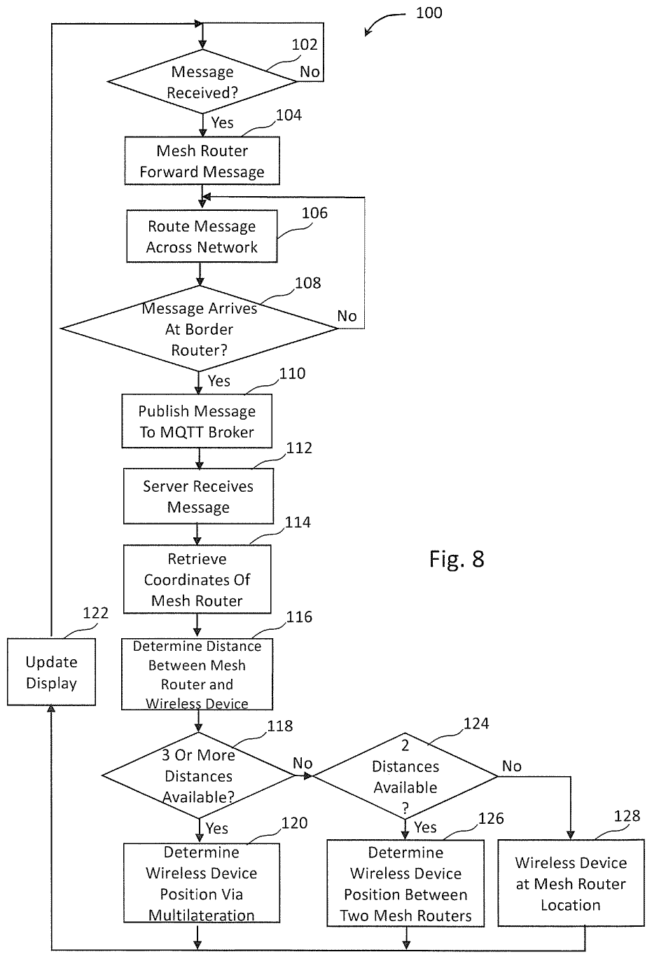

FIG. 4 is a block diagram illustrating typical elements of a server 4 that may be appropriately programmed for tracking the location of personnel at a worksite. The elements include a programmable processor 20 connected to a system memory 22 via a system bus 24. The processor 20 accesses the system memory 22 as well as other input/output (I/O) channels 26 and peripheral devices 28. The server 4 further includes at least one program storage device 30, such as a CD-ROM, tape, magnetic media, EPROM, EEPROM, ROM or the like. The server stores one or more computer programs that implement a method 100 (FIG. 8) for tracking the location of personnel at a worksite according to an embodiment of the present invention. The processor 20 reads and executes the one or more computer programs to perform the method 100. Each of the computer programs may be implemented in any desired computer programming language (including machine, assembly, high level procedural, or object-oriented programming languages). In any case, the language may be a compiled or interpreted language.

The method 100 displays a map of the worksite on a peripheral device 28, such as a display device. The worksite may be classified into different locations and zones, wherein a zone may include one or more adjacent locations. A zone may be an office and a location may be a room in that office. Several adjacent zones may be identified as a wider zone. A hierarchy of zones may thus be defined. The boundary of each location or zone may be defined by geographical coordinates. One or more mesh routers 6 may be deployed in each of these locations. The mesh routers 6 may or may not be displayed in their corresponding locations on the map. Names may be assigned to each location and zone. The wireless devices 8A, 8B that come within range of one or more mesh routers 6 will show up on the map at or near where the one or more mesh routers 6 are deployed. The wireless devices 8A, 8B are assigned to workers and are worn or carried by them. By tracking the position of these wireless devices 8A, 8B, it is thus possible to track the location of the workers within the worksite.

The server 4 further includes a database 30. Records including the name, nationality, identification features, photo, etc. of workers are stored in the database 30. When a worker is issued with a wireless device 8A, 8B, the unique identity number (ID) of the wireless device 8A, 8B is added as another field of the record of that worker in the database 30. The wireless device 8A, 8B may thus be identified on the map by its ID, or the name or initials of the worker obtainable from the record associated with the wireless device ID.

The mesh routers 6 are configured such that they communicate with one another to automatically form a mesh-based network 10 through a mesh networking protocol, such as the Thread protocol. After the mesh-based network 10 is established, the mesh routers 6 are able to route messages therebetween. And when one or more mesh routers fail or become temporarily unavailable, the mesh-based network 10 self-heals. The mesh routers 6 are also able to communicate with the wireless devices 8A, 8B by sending messages to and receiving messages from the wireless devices 8A, 8B.

Each mesh routers 6 is configured to periodically transmit a wakeup message and/or a beacon message. Each of the wakeup and beacon message includes an identity (ID) of the mesh router transmitting the message. For example, a first mesh router 6 may transmit a first wakeup or beacon message including an ID of 001, a second mesh router 6 may transmit a second wakeup or beacon message including an ID of 002, etc. These messages, especially the beacon messages, may be transmitted at random times or offset in time such that a wireless device 8A, 8B may be able to detect them all when the wireless device 8A, 8B is in the vicinity of several mesh routers 6. The wakeup message, or more specifically, wakeup signal carrying the wakeup message, is of a higher signal strength and/or of a longer duration than a beacon signal carrying the beacon message. The longer duration of the wakeup message is achieved by increasing the length of a data packet thereof. The wakeup message is therefore distinguishable from the beacon message.

The wireless device 8A, 8B may be in of a form suitable for wearing by a worker. The wireless device may include, but not limited to, a bracket, a watch, a necklace, a tag, etc. Each wireless device 8A, 8B includes a battery 32 for powering the electronic elements thereof. This battery 32 may be a battery that is rechargeable via a wireless induction style charger (not shown). The electronic elements of the wireless device 8A, 8B includes a processor 34 that is operable in a sleep mode or an active mode, a transceiver 36 and a signal strength detector 38 that are coupled to the processor 34. The wireless device 8A, 8B further includes a timer 40. The sleep mode is typically a low-power operation mode for conserving battery power. The transceiver 36 may in this embodiment include a radio transceiver with a built-in antenna 42 implementing the IEEE 802.15.4 wireless networking protocol operating at 2.4 GHz.

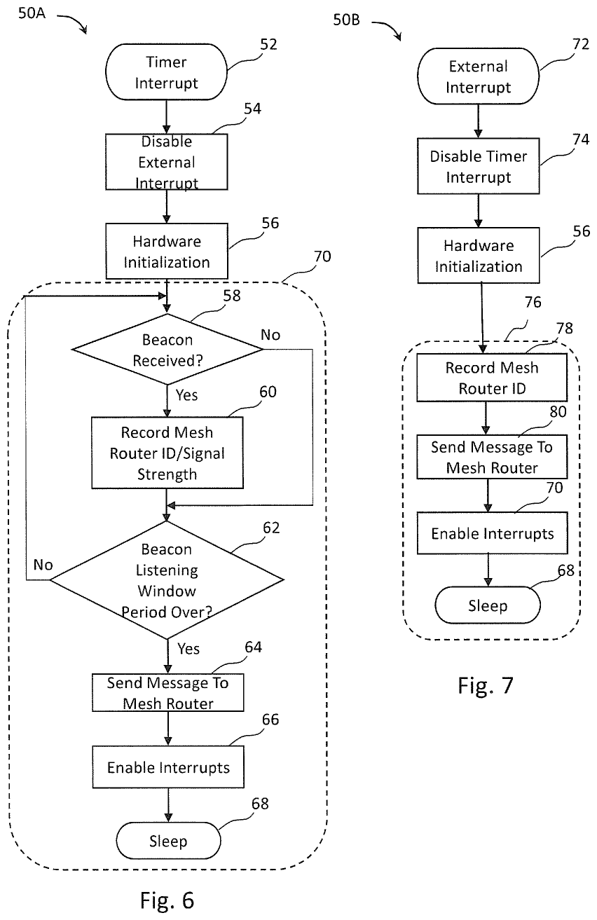

The wireless device 8A, 8B further includes a memory 44 accessible by the processor 34. The wireless device 8A, 8B also includes a program storage device 46, such as a EPROM, EEPROM, ROM or the like. The wireless device 8A, 8B stores one or more computer programs that implement a wireless communication method 50A, 50B (FIGS. 6 and 7) according to an embodiment of the present invention. The processor 34 reads and executes the one or more computer programs to perform the wireless communication method 50A, 50B. Using the transceiver 36, the wireless device 8A, 8B is able to communicate with the mesh routers 6. The wireless device 8A, 8B can receive messages from and send messages to a mesh router 6. Communication between a mesh router 6 and a wireless device 8A, 8B may be full-duplex or half-duplex.

On powerup, the processor of a wireless device 8A, 8B goes into a hardware reset routine to initialize the various electronic elements of wireless device 8A, 8B. In this hardware-reset routine, the processor 34 also sets the timer 40 with a timeout value and enables a timer interrupt 47 and an external interrupt 49. The timeout value may for example be 1-10 minutes. The processor 34 then goes into a sleep mode wherein the wireless device 8A, 8B operates in a power saving mode.

The wireless communication method 50A, 50B is next described with the aid of FIGS. 6 and 7. The wireless communication method 50A, 50B starts when either of the interrupts 47, 49 occurs. When the timer 40 times out to generate the timer interrupt 47, the processor 34 will be interrupted and it goes into an active mode in a TIMER INTERRUPT step 52, wherein the processor 34 executes the wireless communication method 50A in a timer interrupt service routine. The method 50A then proceeds to a DISABLE EXTERNAL INTERRUPT step 54, wherein the external interrupt is disabled so that the processor 34 is not further interrupted when executing this timer interrupt service routine. The method 50A further proceeds to a HARDWARE INITIALIZATION step 56, wherein the processor 34 initializes the necessary electronic elements of the wireless device 8A, 8B. For example, the processor initializes the transceiver 36 so that the transceiver 36 is able to be in data communication with a mesh router 6. Specifically, the transceiver 36 is enabled to be able to receive messages from and transmit messages to the mesh router 6. The wireless communication method 50A then proceeds to a BEACON RECEIVED? decision step 58, wherein the processor 34 checks to see if any beacon message is received from a mesh router 6. Details of how a physical channel is established and the handshaking messages required for negotiation of setting up a communication channel between the wireless device 8A, 8B and a mesh router 6 is omitted here for brevity sake as these are well known to those skilled in the art.

When the processor 34 determines in this BEACON RECEIVED? decision step 58 that a beacon message is received, the processor 34 continues to a RECORD MESH ROUTER ID/SIGNAL STRENGTH step 60, wherein the processor 34 measures the signal strength of the beacon signal and stores the signal strength value and the mesh router ID in its memory 44. The method 50A further proceeds to a BEACON WINDOW PERIOD OVER? decision step 62. If it is however determined in the BEACON RECEIVED? decision step 58 that no beacon message is received, the method 50A bypasses the RECORD MESH ROUTER ID/SIGNAL STRENGTH step 60 to proceed to the BEACON LISTENING WINDOW PERIOD OVER? decision step 62. In the BEACON LISTENING WINDOW PERIOD OVER? decision step 62, the processor 34 determines if a period for determining if a beacon message is present is over. If it is determined in this step 62 that the period for determining if a beacon message is present is not over, the method returns to the BEACON RECEIVED? decision step 58 to continue to monitor for beacon messages from the mesh routers 6. During the period, the wireless device 8A, 8B may thus receive no beacon message at all, or receive one or more beacon messages from different mesh routers 6.

If it is determined in the BEACON WINDOW PERIOD OVER? decision step 62 that the period for determining if a beacon message is present is over, the wireless communication method 50A proceeds to a SEND MESSAGE TO MESH ROUTER step 64, wherein the processor 34 builds a first location reporting message including the wireless device ID, the mesh router IDs and, preferably, signal strength values that are stored in the memory 44 if one or more beacon messages are received. The processor 34 further sends the first location reporting message to one of the mesh routers 6. The wireless device 8A, 8B may send the first location reporting message to the mesh router 6 whose beacon message signal strength is the strongest. If the wireless device 8A, 8B does not receive an acknowledgement from the target mesh router 6, it will continue to send the first location reporting message a predetermined number of times. If no acknowledgement is received from the target mesh router 6, the wireless device 8A, 8B may select another mesh router 6 whose beacon message was received earlier as a new mesh router 6 to send the first location tracking message to.

After the SEND MESSAGE TO MESH ROUTER step 64, the method 50A proceeds to an ENABLE INTERRUPTS step 66, wherein the processor 34 enables both the timer interrupt 47 and the external interrupt 49 before the processor 34 returns to the SLEEP mode 68. The steps 58-68 starting from the BEACON RECEIVED? decision step 58 and ending in the processor returning to the SLEEP mode 68 are herein referred to as a first function 70 performed by the processor 34 of the wireless device 8A, 8B.

Next the wireless communication method 50B is described with the aid of FIG. 7. In the case where the wireless device 8A, 8B is in the vicinity or close to a mesh router 6 transmitting a wakeup message of a predetermined threshold signal strength and duration, the signal strength detector 38 will output a signal to generate the external interrupt 49. The processor 34 will then go into an active mode in an EXTERNAL INTERRUPT step 72 to execute an external interrupt service routine. As mentioned earlier, the wakeup message is distinguishable over the beacon message. Therefore, even if the wireless device 8A, 8B is brought next to a mesh router transmitting beacon messages, the signal strength detector 38 will not be triggered by the beacon messages. The method 50B proceeds to a DISABLE TIMER INTERRUPT step 74, wherein the timer interrupt 47 is disabled so that the processor 34 is not further interrupted when executing the external interrupt service routine. The method 50B next proceeds to the above-described HARDWARE INITIALIZATION step 56. The method 50B further proceeds to execute a second function 76.

In this second function 76, the method 50B proceeds to a RECORD MESH ROUTER ID step 78, wherein the processor 34 stores the mesh router ID in the wakeup message in the memory 44. The method 50B further proceeds to a SEND MESSAGE TO MESH ROUTER step 80, wherein the processor 34 builds a second location tracking message including the wireless device ID and the MESH ROUTER ID that is stored in the memory 44 and sends the second location tracking message to the MESH ROUTER 6 sending the wakeup message. The method 50B further proceeds to an ENABLE INTERRUPTS step 82, wherein the processor 34 enables both the timer interrupt 47 and the external interrupt 49 before the processor 34 returns to the SLEEP mode. The second function 76 ends with this step 68.

The mesh routers 6 receiving the first and the second location tracking messages from the wireless devices 8A, 8B forward the messages to the server 4. Depending on the communication protocol used between the mesh routers 6 and the server 4, a mesh router 6 receiving the message from a wireless device 8A, 8B may simply forward the message to the server by changing its destination address. Or the mesh router 6 may build another data package according to the communication protocol for sending the information contained in the first and the second location tracking message to the server 4. If the server 4 also functions as a mesh router 6, first and second location tracking messages received by the server 4 may not be required to be forwarded. If however, there are other servers 4 in the system 2, this server 4 upon receiving the first and second location tracking messages may forward the messages to the other servers 4.

Next, the location tracking method 100 by which the first and the second location tracking messages received by the mesh routers 6 are routed to the server 4 is described with the aid of FIG. 8. The location tracking method 100 begins in a MESSAGE AVAILABLE? decision step 102, wherein a mesh router 6 determines if it has received any first or second location tracking message. If it is determined in this step 102 that no location tracking message is available, the method 100 loops around this step 102. If however it is determined in this MESSAGE AVAILABLE? decision step 102 that a location tracking message is available, the location tracking method 100 proceeds to a MESH ROUTER FORWARDS MESSAGE step 104, wherein the mesh router 6 receiving the location tracking message from a wireless device 8A, 8B forwards the location tracking message to the server 4. The method 100 proceeds to a ROUTE MESSAGE ACROSS NETWORK step 106, wherein one or more mesh routers 6 route the location tracking message to the server 4 based on a predetermined route across the network 10. The method 100 next proceeds to a MESSAGE ARRIVED AT BORDER ROUTER? decision step 108. When it is determined in this MESSAGE ARRIVED AT BORDER ROUTER? decision step 108 that the location tracking message has yet to arrive at the border router 14, the method 100 returns to the ROUTE MESSAGE ACROSS NETWORK step 106. If however it is determined in the MESSAGE ARRIVED AT BORDER ROUTER? decision step 108 that a location tracking message has arrived at a border router 14, the method 100 proceeds to a PUBLISH MESSAGE to MQTT BROKER step 110, wherein the location tracking message is published to an MQTT broker (not shown) under a specific topic name, to which the program running on the server 4 subscribes to. The method 100 next proceeds further to a SERVER RECEIVES MESSAGE step 112, wherein the location tracking message is finally delivered to the program running on the server 4. The method 100 further proceeds to a RETRIEVE COORDINATES OF MESH ROUTERS step 114, wherein the server 4 retrieves the geographical coordinates of the respective mesh routers 6 from the database based on the mesh router IDs in the received location tracking message. The method 100 further proceeds to a DETERMINE DISTANCE BETWEEN MESH ROUTER AND WIRELESS DEVICE step 116, wherein the server 4 calculates the distance between each of the mesh router 6 and the wireless device 8A, 8B using the signal strength values in the location tracking message based on a free space path loss method known to those skilled in the art. If no signal strength value is available in the location tracking message, the distance is fixed at some preselected value. For example, the preselected value may be a worst case value determined based on the furthest distance by which communication between a mesh router 6 and a wireless device 8A, 8B is possible. Alternatively, the preselected value may be an average value. The method 100 next proceeds to a 3 OR MORE DISTANCES AVAILABLE? decision step 118, wherein the server 4 determines if three or more distances have been determined in the previous DETERMINE DISTANCE BETWEEN MESH ROUTER and WIRELESS DEVICE step 116. If it is determined in the 3 OR MORE DISTANCES AVAILABLE? decision step 118 that there are 3 or more distances available, the method 100 proceeds to a DETERMINE WIRELESS DEVICE POSITION VIA MULTILATERATION step 120, wherein the server 4 performs a multilateration algorithm in order to determine an estimated position of the wireless device 8A, 8B within the worksite based on the 3 or more distances obtained. The algorithm determines the estimated position of the wireless device with respect to the mesh routers 6 based on these distances. The server 4 then updates the record in the database 30 associated with the wireless device 8A, 8B with the latest position of the wireless device 8A, 8B. The method 100 further proceeds to an UPDATE DISPLAY step 122, wherein the server 4 displays on the map an indicium indicating the position of the wireless device 8A, 8B. The method 100 then returns to the MESSAGE AVAILABLE? decision step 102.

If it is determined in the 3 OR MORE DISTANCES AVAILABLE? decision step 118 that there are less than three distances available from the DETERMINE DISTANCE BETWEEN MESH ROUTER AND WIRELESS DEVICE step 116, the method 100 proceeds to a 2 DISTANCES AVAILABLE? decision step 124, wherein the server 4 determines if there are two distance values obtained in the DETERMINE DISTANCE BETWEEN MESH ROUTER AND WIRELESS DEVICE step 116. If it is determined that there are indeed only two distance values available, the method 100 proceeds to a DETERMINE WIRELESS DEVICE POSITION BETWEEN TWO MESH ROUTERS step 126, wherein the server 4 determines the position of the wireless device 8A, 8B based on the two distance values. The method 100 then proceeds to the UPDATE DISPLAY step 122, wherein the server 4 displays on the map an indicium indicating the position of the wireless device between the two mesh routers 6. The method 100 further returns to the MESSAGE AVAILABLE? decision step 102 to wait for the arrival of another location tracking message. If it is determined in the 2 DISTANCES AVAILABLE? decision step 124 that the number of distance values is not equal to two, the method 100 proceeds to a WIRELESS DEVICE AT MESH ROUTER LOCATION step 128, wherein the server 4 determines that the wireless device 8A, 8B is at the location of the mesh router 6 whose mesh router ID is in the location tracking message. The method 100 proceeds to the UPDATE DISPLAY step 122, wherein the server 4 displays on the map an indicium indicating the position of the wireless device 8A, 8B. The method 100 ends by returning to the MESSAGE AVAILABLE? decision step 102, wherein the server 4 waits for the arrival of another location tracking message.

With the position information of the wireless devices 8A, 8B captured in the database 30, an operator of the system 2 will be able to generate reports by querying the database 30. For example, a report for identifying workers that are not qualified or allowed to be in a specific location or zone can be generated. Each location or zone has its criteria for determining if a worker is qualified to be in that location or zone. The criteria may be based on information such as, but not limited to, the following:
types of training completed by a worker,
physical attributes and/or health status of a worker,
employment type (whether the worker is a direct employee, on contract, is a subcontractor, etc.),
employee status level of a worker,
employee statistics of a worker,
worker's length of service with the company,
asset type in the location or zone,
date and time of day of access, and
danger level of the location or zone.

For those workers who are not allowed in a location or zone, the server 4 is able to send an out-of-bound message to their respective wireless devices 8A, 8B via one or more mesh routers 6 deployed where the wireless devices 8A, 8B are determined to be last located. The wireless device 8A, 8B on receiving this out-of-bound message can for example generate a suitable visual, audio or vibratory alert for the worker.

As another example, the system 2 may further include detection systems for detecting safety hazards such as lightning, fire, gas leaks, unsafe equipment or process, etc. In the case of lighting, several lightning detectors may be deployed in the worksite. An area within a certain radius may be marked out around each lightning detector to indicate that the area is an unsafe zone. This area is then mapped onto the locations and zones described earlier. When the lightning detector detects a lightning strike, those workers in the locations and zones corresponding to the unsafe area may be alerted. For example, the server 4 may send a lightning alert message to each wireless device 8A, 8B in the unsafe area. Again, a wireless device 8A, 8B on receiving this lightning alert message can for example generate a suitable visual, audio or vibratory alert for the worker.

Similarly, a flame detector has a field of vision. When deployed, the field of vision of a flame detector may be mapped to one or more corresponding locations and zones. When the flame detector detects a flame, the workers in the locations and zones corresponding to the field of vision of the flame detector can be alerted. Likewise, point gas detectors are deployed in a similar manner to the above described lightning detector. The area defined by a radius around where a point gas detector is deployed may be designated an unsafe area when that point gas detector detects a gas leak. This unsafe area may be mapped to corresponding locations and zones. In the event of a gas leak, the workers in the unsafe area may be alerted. Another type of gas detector is the line-of-sight gas detector having a transmitter and a receiver or a retroreflector. When deployed, the area between the transmitter and the receiver or the retroreflector may be marked out as an unsafe zone.

As yet a further example, the system may include what is known as a safety instrumented system that constantly monitors equipment or processes for unsafe conditions. Like the lighting detector and point gas detectors described above, an unsafe area may be defined around where the safety instrumented system is deployed. Once the safety instrumented system detects an unsafe condition, those workers in the unsafe area may again be alerted.

In addition to sending alert messages to wireless devices, the server 4 may send other types of messages to wireless devices 8A, 8B. As an example, the above-described embodiments both the timer and external interrupts 47, 49 are enabled when a wireless device 8A, 8B is in a sleep mode. However, it is not to be construed to be limited as such. The server 4 may be configured to send a TURN TIMER ON/FF message to a wireless device 8A, 8B to enable or disable the timer interrupt 47. Such a feature will be useful when a worker leaves a worksite for his dormitory connected to the worksite via a passageway. A first mesh router 6 is deployed at a worksite choke point of the passageway and a second mesh router 6 is deployed at a dormitory choke point of the passageway. A worker leaving the worksite for the dormitory will have his position captured initially by the first mesh router 6 and subsequently the second mesh router 6 as the exits the passageway. The server 4 detecting such an egress of the worksite may then send a TURN TIMER ON/OFF message to the wireless device of the worker to disable the timer interrupt 47, leaving only the external interrupt 49 enabled. In such a mode where the timer interrupt 47 is disabled, no timer interrupt will occur, and the first function 70 will not be executed at all. As there may be no other mesh routers 6 deployed in the workers' quarter, the wireless device 8A, 8B will remain in the sleep mode for an extended period, thus effectively conserving battery life. When the worker returns to the worksite through the passageway, his position is captured initially by the second mesh router 6 and subsequently by the first mesh router 6. The server 4 detecting such an ingress of the worksite may then send a TURN TIMER ON/OFF message to the wireless device 8A, 8B of the worker to once again enable the timer interrupt 47 so that the wireless device will function as described above. Alternatively, the first and the second mesh routers 6 may on their own, without any instruction from the server 4, send the TURN TIMER ON/OFF messages to the wireless device 8A, 8B. The TURN TIMER ON/OFF message may include an ID of a wireless device 8A, 8B whose timer is to be turned on or off.

As another example, the server 4 may be configured to broadcast a TIMER VALUE CHANGE message. This TIMER VALUE CHANGE message includes a timeout value therein. The wireless device 8A, 8B receiving such a message changes its timeout value to that contained in the message. Such a feature is especially useful in an emergency scenario where up-to-date position of a wireless device 8A, 8B is obtained more regularly than once in a few minutes. The timeout value in the wireless device may thus be changed to for example, ten seconds, such that the server 4 is able to determine the position of the wireless device 8A, 8B once every 10 seconds.

Alternatively, the shorter timeout value may be hardcoded in the wireless device 8A, 8B. And in an emergency scenario, the server 4 may be configured to broadcast a muster command to the wireless devices in the system. Upon receiving the muster command, the wireless devices 8A, 8B change the timeout value to the shorter timeout value so as to increase its frequency of coming out of the sleep mode to monitor for beacon messages. After it has been determined that the emergency has passed, an all-clear command can be broadcast to the wireless devices 8A, 8B. After receiving the all clear command, the timeout value in the wireless devices can revert to the default value for conserving battery life of the wireless device 8A, 8B.

As yet a further example, when highly flammable material is to be transported to a location or zone, it may be necessary for all radio frequency (RF) sources to be turned off. In this scenario, the server 4 may send an RF shutdown command to all wireless devices 8A, 8B located within the location or zone. Upon receiving the RF shutdown command, each wireless device 8A, 8B sends at least one acknowledgement message. The server 4 after verifying that all wireless devices 8A, 8B in the location or zone have been accounted for may then declare the location or zone to be safe for transporting the highly flammable material through the location or zone. After sending the acknowledgement message, each wireless device 8A, 8B goes into the sleep mode for a predetermined period that is long enough to allow the highly flammable material to be transported through the location or zone. The predetermined period may be included in the RF shutdown command. After the predetermined period has elapsed, the wireless device 8A, 8G may periodically wake up and enter into an RF receive only mode to check for messages from the mesh routers 6. After the highly flammable material has been transported out of the location or zone, the server 4 may send an all-clear command to the wireless devices 8A, 8B. Upon receiving the all-clear command, the wireless devices may return to their full RF transmit and receive mode for operation as described above. Likewise, acknowledgement of receipt of the all-clear command may be sent by the wireless devices 8A, 8B so that the server 4 may determine that all wireless devices 8A, 8B whose RF was shut down earlier are now back online.

Advantageously, the system described above is able to track the location of personnel on a worksite in a more efficient and less error-prone manner. The wireless communication method between the wireless device 8A, 8B and the mesh router 6 is also able to extend the battery life of the wireless device 8A, 8B so that the wireless device can be used for a longer period between battery charges. However, during an emergency the wireless device 8A, 8B is configurable to report its location on a more regular basis so that safety of a worker is not compromised. And in an environment where RF poses a safety threat, the RF function of a wireless device 8A, 8B may be temporarily disabled. And when it is not necessary to track the location of a wireless device 8A, 8B, the wireless device 8A, 8B may be placed in a sleep mode to further converse battery power.

Although the present invention is described as implemented in the above described embodiment for tracking personnel on a worksite, it is not to be construed to be limited as such. For example, the invention may be implemented in an embodiment for asset tracking. As another example, only one server 4 is described in the above described embodiment. However, more than one such servers 4 may be used as a cluster in the system with the intention of increasing reliability of the system. As yet a further example, multiple protocol stacks may also be implemented in a mesh router 6 so that the mesh router 6 is able to communicate with a variety of wireless devices supporting different protocols.

It should be further appreciated by the person skilled in the art that one or more of the above modifications or improvements, not being mutually exclusive, may be further combined to form yet further embodiments of the present invention.

1. A wireless device for data communication with at least one base station, the wireless device having an ID and comprising:
a processor being operable in a sleep mode and an active mode;
a transceiver coupled to the processor;
a timer configurable to timeout after a predetermined period to bring the processor from the sleep mode to the active mode to perform a first function comprising:
receiving, via the transceiver, a beacon message from each of at least two base stations, each beacon message including an ID of the respective base station; and
transmitting, via the transceiver, a first location reporting message that includes the wireless device ID and the base station IDs of the at least two base stations; and
a signal strength detector coupled to the processor, the signal strength detector being able to receive a wakeup message from a base station for bringing the processor from the sleep mode to the active mode to perform a second function, the wakeup message including an ID of the base station, the second function comprising:
transmitting, via the transceiver, a second location reporting message that includes the wireless device ID and the base station ID.

2. The wireless device according to claim 1, wherein the wakeup message is of a longer duration than the beacon message.

3. The wireless device according to claim 2, wherein the wakeup message is of a higher signal strength than the beacon message.

4. The wireless device according to claim 1, wherein receiving a beacon message comprises receiving a beacon message during a beacon listening period when the processor is in the active mode, and wherein sending the first location reporting message comprises sending the first location reporting message at the end of the beacon listening period, and the first function further comprising returning the processor to the sleep mode after sending the first location reporting message.

5. The wireless device according to claim 1, wherein the second function further comprises returning the processor to the sleep mode after sending the second location reporting message.

6. The wireless device according to claim 1, wherein the first reporting message further includes a signal strength of each beacon message.

7. The wireless device according to claim 1, wherein at least one of the first function and the second function further comprises receiving a timer value change message from the at least one base station for changing the predetermined period of the timer.

8. The wireless device according to claim 1, wherein at least one of the first function and the second function further comprises receiving a turn timer on/off message from the at least one base station for turning the timer on or off.

9. A system comprising:
at least one wireless device for data communication with at least one base station, each wireless device having a respective ID and comprising:
a processor being operable in a sleep mode and an active mode;
a transceiver coupled to the processor;
a timer configurable to timeout after a predetermined period to bring the processor from the sleep mode to the active mode to perform a first function comprising:
receiving, via the transceiver, a beacon message from each of at least two base stations, each beacon message including an ID of the respective base station; and
transmitting, via the transceiver, a first location reporting message that includes the wireless device ID and the base station IDs of the at least two base stations; and
a signal strength detector coupled to the processor, the signal strength detector being able to receive a wakeup message from a base station for bringing the processor from the sleep mode to the active mode to perform a second function, the wakeup message including an ID of the base station, the second function comprising:
transmitting, via the transceiver, a second location reporting message that includes the wireless device ID and the base station ID.

10. The system according to claim 9, wherein the wakeup message is of a longer duration than the beacon message.

11. The system according to claim 10, wherein the wakeup message is of a higher signal strength than the beacon message.

12. The system according to claim 9, wherein receiving a beacon message comprises receiving a beacon message during a beacon listening period when the processor is in the active mode, and wherein sending the first location reporting message comprises sending the first location reporting message at the end of the beacon listening period, and the first function further comprising returning the processor to the sleep mode after sending the first location reporting message.

13. The system according to claim 9, wherein the second function further comprises returning the processor to the sleep mode after sending the second location reporting message.

14. The system according to claim 9, wherein the first reporting message further includes a signal strength of each beacon message.

15. The system according to claim 9, wherein at least one of the first function and the second function further comprises receiving a timer value change message from the at least one base station for changing the predetermined period of the timer.

16. The system according to claim 9, wherein at least one of the first function and the second function further comprises receiving a turn timer on/off message from the at least one base station for turning the timer on or off.

17. The system according to claim 9, further comprising: the at least one base station, each base station being operable to transmit at least one of a respective wakeup message and a respective beacon message, and to receive the first location reporting message and the second reporting message.

18. The system according to claim 17, further comprising:
a server coupled to the at least one base station, the server being operable to receive the first location reporting message and the second location reporting message from the at least one base station for determining a location of the at least one wireless device.

19. A base station for communicating with a plurality of wireless devices, each wireless device having a timer, the base station comprising:
a processor; and
a transceiver coupled to the processor;
wherein the processor is operable to broadcast to the wireless devices, via the transceiver, at least one of a wakeup message and a beacon message, and the processor is operable to further broadcast to the wireless devices, via the transceiver, a turn timer on/off message.

20. The base station according to claim 19, wherein the turn timer on/off message includes an ID of each wireless device whose timer is to be turned on or off.
